(19) United States
(12) Patent Application Publication
(10) Pub. No.: US 2007/0268846 A1
(43) Pub. Date: Nov. 22, 2007

(54) Enhanced physical layer repeater for operation in WiMAX systems

(75) Inventors: James A. Proctor JR., Melbourne Beach, FL (US); Kenneth M. Gainey, Satellite Beach, FL (US); James C. Otto, West Melbourne, FL (US)

Correspondence Address: POSZ LAW GROUP, PLC, 12040 SOUTH LAKES DRIVE, SUITE 101, RESTON, VA, 20191, US

(73) Assignee: WIDEFI, INC., Melbourne, FL (US)

(21) Appl. No.: 11/730,361

(22) Filed: Mar. 30, 2007

Related U.S. Application Data
(60) Provisional application No. 60/787,547, filed on Mar. 31, 2006.

(51) Int. Cl. H04B 7/14

(52) U.S. Cl. 370/279

(57) ABSTRACT

A method and repeater are described for repeating using a time division duplex (TDD) radio protocol. A signal is transmitted from a first station to a second station using a downlink and an uplink. The signal can be detected on the uplink or the downlink. The repeater can synchronize to time intervals associated with the detected signal that are measured during an observation period. The signal can be retransmitted from the second station to the first station if the signal is detected on the uplink and re-transmitted from the first station to the second station if the signal is detected on the downlink. A gain value associated with the downlink can be used to establish a gain value associated with the uplink.

### CROSS REFERENCE TO RELATED APPLICATIONS

The present invention is related to and claims priority from U.S. Provisional Patent Application 60/787,547 filed Mar. 31, 2006 the contents of which are incorporated herein by reference, and U.S. patent application Ser. No. 11/127,320, filed May 12, 2005 the contents of which are incorporated herein by reference.

### BACKGROUND OF THE INVENTION

The present invention relates generally to wireless networks and, particularly, the present invention relates to Time Division Duplex (TDD) repeaters and time slot detection and automatic gain control (AGC), synchronization, isolation and operation in a non-frequency translating repeater.

Several emerging protocols and/or specifications for wireless local area networks, commonly referred to as WLANs, or wireless metropolitan area networks known as WMANs, are becoming popular including protocols such as 802.11, 802.16d/e, and related protocols also known by names such as “WiFi,” “WiMAX,” Mobile WiMAX, time division synchronization code division multiple access (TDS-CDMA), broadband wireless access or “WiBro” systems, and the like. Many of these protocols, such as WiBro for example, are gaining popularity as a low cost alternative in developing nations for providing network access in a WMAN, or cellular-like infrastructure.

While the specifications of products using the above standard wireless protocols commonly indicate certain data rates and coverage ranges, these performance levels are often challenging to realize. Performance shortcomings between actual and specified performance levels can have many causes including attenuation of the radiation paths of RF signals, which for 802.16d/e is typically associated with a 10 MHzchannel in the 2.3 to 2.4 GHz licensed band although 802.16 can support transmission frequencies up to 66 GHz. Of particular interest, due in part to its wide acceptance in the global market place, are systems such as WiBro as noted above, which operate using a Time Division Duplex (TDD) protocol.

Problems arise in that structures such as buildings where wireless network support is desired may have floor plans including obstructing wall placements and the like, and may have construction based on materials capable of attenuating RF signals, all of which may prevent adequate coverage. Still further, data rates of devices operating using the above standard wireless protocols depend heavily on signal strength. As distances in the area of coverage increase, wireless system performance typically decreases. Lastly, the structure of the protocols themselves may affect the operational range.

Repeaters are commonly used in the wireless industry to increase the range and in-building penetration of wireless systems. However, problems and complications arise in that system receivers and transmitters in any given device may, for example, in a TDD system operate within an allocated time slot. In such systems, when multiple transmitters operate simultaneously, as would be the case in repeater operation, difficulties may arise. Some TDD protocols provide defined receive and transmit periods and, thus, are resistant to collisions.

In a TDD system, receive and transmit channels are separated by time rather than by frequency and further, some TDD systems such as 802.16(e) systems, use scheduled times for specific uplink/downlink transmissions. Other TDD protocols such as 802.11 do not use scheduled time slots structured. Receivers and transmitters for full duplex repeaters intended for operation in TDD systems may be isolated by any number of means including physical separation, antenna patterns, frequency translation, or polarization isolation. An example of isolation using frequency translation can be found in International Patent Application No. PCT/US03/28558 entitled “WIRELESS LOCAL AREA NETWORK WITH REPEATER FOR ENHANCING NETWORK COVERAGE”, Attorney docket number WF02-05/27-003-PCT, based on U.S. Provisional Application No. 60/414,888. It should be noted however, that in order to ensure robust operation, a non-frequency translating repeater in order to operate effectively must be capable of rapidly detecting the presence of a signal and operating cooperatively with the media access control and overall protocol associated with the TDD system in which it is repeating in order to effectively repeat the transmission on a timeslot.

Of further concern is the synchronization of the repeater with the transmissions conducted under the TDD protocol and gain control. If excessive gain control is utilized, then modulation can be eliminated resulting in distortion, or signal loss. For further information regarding automatic gain control, reference can be made to International Patent Application No. PCT/US03/29130 entitled “WIRELESS LOCAL AREA NETWORK REPEATER WITH AUTOMATIC GAIN CONTROL FOR EXTENDING NETWORK COVERAGE”, Attorney docket number WF02-04/27-008-PCT, based on U.S. Provisional Application No. 60/418,288. In addition, the specific gain control method must not adversely affect the system level performance of the base station to subscriber link and must not adversely affect network performance while many subscribers are concurrently operating in the system.

A TDD system in accordance with 802.16(e), as will be appreciated by one of ordinary skill in the art has designated subcarriers for the uplink and designated subcarriers for the downlink on designated channels having a certain bandwidth and a plurality of traffic time slots each of which may be assigned to one or more subscriber stations on subcarriers within a specified bandwidth. For each connection established within a TDD system, operating under the 802.16 standards and protocols, as will be appreciated, use a known frequency channel for all time slots. WiBro is one such profile of 802.16(e) which is described in the Appendices submitted herewith.

### SUMMARY OF THE INVENTION

Accordingly, in various exemplary and alternative exemplary embodiments, the present invention extends the coverage area in a wireless environment such as a WLAN environment, and, broadly speaking, in any time division duplex system including IEEE 802.16, IEEE 802.20, PHS, and TDS-CDMA, with a dynamic frequency detection method and repeating method which can perform in systems using scheduled uplink and downlink timeslots or unscheduled random access, for example, as used in 802.11 based systems. Further, an exemplary repeater can operate in synchronized TDD systems such as 802.16 and PHS systems where the uplink and downlink repeating direction can be determined by a period of observation or by reception of broadcast system information. An exemplary WLAN non-frequency translating repeater allows two or more unsynchronized WLAN nodes or nodes that would typically communicate on a scheduled basis to communicate in accordance with a synchronized scheme. Unsynchronized WLAN nodes typically generate non-scheduled transmissions, while other nodes such as a subscriber unit and a base station unit are synchronous and communicate based on scheduled transmissions.

Such units can communicate in accordance with the present invention by synchronizing to a control slot interval or any regular downlink interval on, for example, a narrow band downlink control channel as in a PHS system, and repeat a wider bandwidth set of carrier frequencies to a wideband repeated downlink. In other systems such as in 802.16 systems, the control time slot detection bandwidth will be the same as the repeated bandwidth. On the uplink side, the repeater preferably monitors one or a number of slots for transmission on the subscriber side by performing wideband monitoring, and when an uplink transmission is detected, the received signal can be repeated on the uplink channel toward the base station equipment. In accordance with a various exemplary embodiments, the repeater will preferably provide a direct repeating solution where the received signal is transmitted on essentially the same time slot including any repeater delay.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram illustrating an exemplary non-frequency translating repeater in accordance with various exemplary embodiments.

FIG. 2 is a diagram illustrating an exemplary non-frequency translating repeater environment including a subscriber side and a base station side.

FIG. 3 is a schematic drawing illustrating an exemplary detection and repeater circuit associated with an exemplary non-frequency translating repeater.

FIG. 4 is a is a diagram illustrating an orthogonal frequency division multiple access (OFDMA) frame associated with various embodiments of an exemplary non-frequency translating repeater.

FIG. 5 is a flow diagram illustrating repeater synchronization with TDD intervals associated with various embodiments of an exemplary non-frequency translating repeater.

FIG. 6 is a diagram illustrating a synchronization scheme associated with various embodiments of an exemplary non-frequency translating repeater.

FIG. 7 is a diagram illustrating a power control scheme associated with various embodiments of an exemplary non-frequency translating repeater.

FIG. 8 is a circuit diagram illustrating an exemplary repeater configuration associated with various embodiments of a non-frequency translating repeater.

FIG. 9 is a circuit diagram illustrating an exemplary detector associated with various embodiments of an exemplary non-frequency translating repeater.

### DETAILED DESCRIPTION OF THE INVENTION

In accordance with various embodiments, a method is disclosed for repeating a signal transmitted from a first station such as a base station (BS) to a second station such as a subscriber station (SS) using a repeater configured according to a Time Division Duplex (TDD) protocol. The first station generally communicates to the second station on a downlink and the second station communicates to the first station on an uplink. The presence of the signal can be detected on the uplink or the downlink depending for example on whether the signal originates from the BS or SS using a power detector, correlator, matched filter or the like. One or more gaps between an uplink interval and a downlink interval can also be detected using a windowing function. The repeater can be synchronized to one or more time intervals associated with the detected signal that are measured during an observation period. The length of the observation period depends on factors such as the degree of accuracy required. The signal can be re-transmitted from the second station to the first station if the signal is detected on the uplink and from the first station to the second station if the signal is detected on the downlink. A gain value associated with the downlink is used to establish a gain value associated with the uplink.

To perform synchronizing a received signal strength indicator (RSSI) vale or a correlation value associated with samples of the signal can be measured during the one or more measured time intervals. One or more signal processing bins can be filled with the measured values associated with the measured time intervals such that the measured time intervals are established by processing the one or more signal processing bins using a statistical procedure such as a power envelope sliding correlation function after the observation period expires.

In accordance with various embodiments, the TDD protocol can include an IEEE 802.16 protocol, such as an IEEE 802.16(e), IEEE 802.16(d), or IEEE 802.16 protocol(d/e) protocol, or can include an IEEE 802.20 protocol a Personal Handy-phone System (PHS) protocol, a time division synchronization code division multiple access (TDS-CDMA) protocol or the like. The gain value can include an automatic gain control (AGC) level for the downlink and, on the uplink, the gain value includes can include a power control value. Further, an isolation can be measured between the uplink and the downlink and providing an indication of the isolation. The exemplary repeater can further be divided into a first unit and a second unit that communicate over a communication link.

In accordance with other embodiments, a repeater repeats a signal transmitted from a first station such as a BS to a second station such as a SS according to a TDD protocol. The first station communicates to the second station on a downlink and the second station communicates to the first station on an uplink. The repeater includes at least one antenna, a detector configured to detect the presence of the signal in an uplink or downlink interval, and a processor configured to measure time intervals during an observation period associated with the detected signal. The repeater can be synchronized to the time intervals such that a first one of the measured time intervals corresponds to uplink intervals and a second of the measured time intervals corresponds to downlink intervals. A transmitter and gain controller can be used to re-transmit the signal from the first station to the second station on one of the downlink intervals, the gain controller controlling a downlink gain value of the retransmitted signal if the signal is detected on the downlink. The signal can alternatively be re-transmitted from the second station to the first station on one of the uplink intervals, the gain controller controlling an uplink gain value if the signal is detected on the uplink. It will be appreciated that the downlink gain value can be used to establish the uplink gain value.

It will be appreciated that the processor can include a high performance processor such as a signal processor, which, when performing synchronizing can be configured to measure one of a received signal strength indicator (RSSI) value, a correlation value, or the like associated with the signal at a sampling interval to form a measured value. Statistical signal processing bins as will be appreciated by one of skill in the art, such as registers or the like, can be filled with values associated with the measured time intervals. The boundaries of the timing intervals are thereby established by processing the signal processing bins using a statistical procedure, such as a power envelope sliding correlation function, after the observation period expires. Alternatively, or in addition to statistical signal processing, the detector and the processor can be configured to detect one or more gaps between an uplink interval and a downlink interval using a windowing function. The processor can further be configured to measure an isolation between the uplink and the downlink and provide an indication of the isolation.

In still other embodiments, an exemplary repeater can include a first unit and a second unit that may be separately located but linked with a communication link. Each of the first and second units can include an antenna, a transmitter, a detector configured to detect the presence of the signal coupled to the antenna in an interval associated with the uplink or the downlink, a transmitter, and a processor configured to measure a time intervals during an observation period associated with the detected signal, synchronize the repeater to the time intervals such that a first one of the time intervals corresponds to an uplink interval and a second one of the time intervals corresponds to a downlink intervals. The first unit can be configured to transfer the signal from the first station to the second unit over the communication link, in one of the downlink intervals using a first gain value associated with the signal set by the second unit if the signal is detected on the downlink. The second unit can be configured to re-transmit the signal to the second station in one of the one or more downlink intervals at the first gain value. The second unit can be configured to transfer the signal from the second station to the first unit over the communication link, in one of the uplink intervals using a second gain value associated with the signal set by the first unit if the signal is detected on the uplink. The first unit is accordingly configured to re-transmit the signal to the first station in one of the uplink intervals at the second gain value.

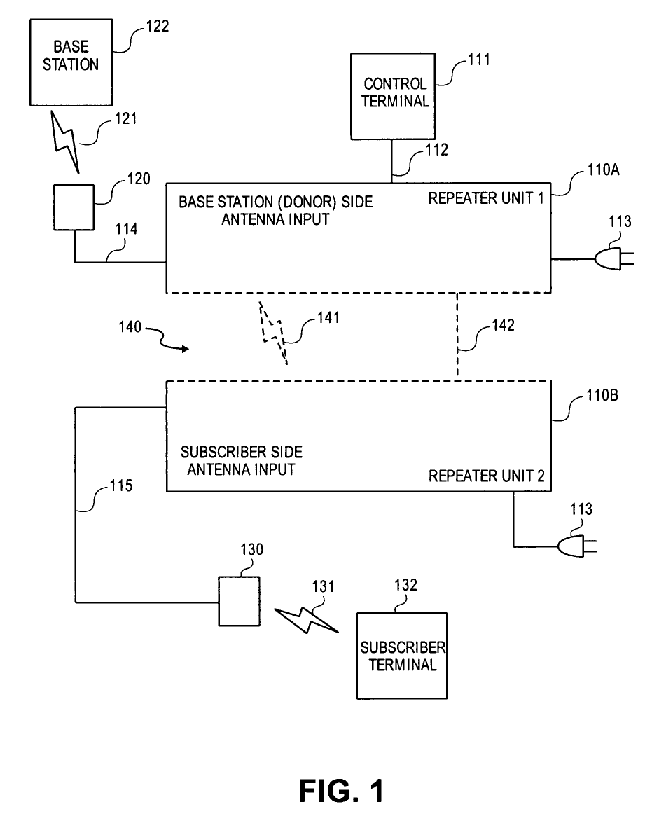

Referring now to FIG. 1, an exemplary non-frequency translating repeater 110 is shown. The repeater 110 can include a control terminal 111 connected to the repeater 110 through a communication link such as a link 112 which can be a RS-232 connection or the like for conducting serial communication for various purposes such as to configure the repeater 110, collect various metrics, or the like. It will be appreciated that in a production model of the repeater 110, such a connection will not likely be used since the configuration will be completed during manufacturing or the repeater 110 will be automatically configured under control of, for example, a microprocessor, controller, or the like. The repeater 110 system may also include an external antenna 120 for communicating with one side of a TDD repeater connection such as a base station 122 through a wireless interface 121. It will be appreciated that the base station 122 can refer to any infrastructure node capable of serving multiple subscribers, such as the WiBro profile of 802.16(e) a PHS cell station (CS), or the like. The antenna 120 can be coupled to the repeater 110 through a connection 114 which can be accomplished using a direct coupled connection such as by using a coaxial cable and SMA connector or other direct connection as will be appreciated by one of ordinary skill in the art.

Another antenna 130 can be used to communicate to another side of the TDD repeater connection such as a subscriber terminal 132 through a wireless interface 131. The subscriber terminal 132 will be used herein refer to a device configured to receive service from the base station 122 as a user entity, user equipment, terminal equipment, such as an 802.16(e) subscriber station (SS), a PHS personal station (PS), or the like. The antenna 130 can be coupled to the repeater 110 through a connection 115 which can be accomplished using a direct coupled connection such as by using a coaxial cable and SMA connector as noted above. The repeater 110 will be powered by a standard external DC power supply.

It will also be appreciated that in some embodiments the antennas 120 and 130 may be directional antennae and may also be integrated into a single package with repeater circuitry associated with the repeater 110 such that, for example, one side of the package can be directed in one direction such as toward a base station and the other side of the package or enclosure can be directed in another direction such as toward a subscriber or the like when mounted in a window or an external wall of a structure. Further, the antennae 120 and 130 may be directed or omni-directional in their radiation pattern. For a personal internet (PI) repeater, it is expected that one antenna will be mounted outside of a building, and the other antenna will be situated inside of the building. The PI repeater may also be situated inside of the building. It will also be appreciated that many different form factors can be used to accomplish the proper placement and configuration. For example, cross-polarized antennae can be used such as cross-polarized patch antennae, planar antennae, strip antennae or the like can be used as will be appreciated by one of ordinary skill in the art. Further, two such antennae can be used, one for input and one for output or the like as will be appreciated. In a typical scenario, one of the antennae 120 and 130, in the present example the antenna 120, can be defined as the “donor” antenna, that is, the antenna coupled to the base station 122.

In accordance with some embodiments, the repeater 110 can include a unit 1 110a and a unit 2 110b that can be connected through a link 140 such as a communication link, data and control link, or the like. The unit 1 110a can be positioned to communicate with the base station 122 and the unit 2 110b can be positioned to communicate with the subscriber terminal 132. The unit 1 110a and the unit 2 110b can communicate analog information or digital information through the link 140 which can be a wireless link 141 or a wired link 142. The wired link can include a coaxial cable, a telephone line, a household power wiring circuit, a fiber optic cable, or the like. The unit 1 110a and the unit 2 110b can perform filtering in such as with a matched filter in order to ensure that no unwanted signal is passed on to the core frequencies being used for repeating. It will be appreciated that a different frequency can be used between the unit 1 110a and the unit 2 110b so as to reduce the possibility of interference. It will be appreciated that a protocol such as 802.11 can be used between the units and, in such a case, the signals transferred between the units on link 140 can be demodulated and passed between the units as 802.16 data in an 802.11 packet and re-encapsulated for repeating purposes, e.g. for transmission to the base or subscriber stations. Or the 802.11 packets can contain digital samples such as a Nyquist sample of the repeated signal. Thus an inter-unit synchronization protocol is preferably used.

It will be appreciated that by separating the exemplary repeater into units, better isolation can be achieved. Alternatively, isolation can be achieved in a single unit repeater by antenna placement, the use of directional antenna or the like. In either a one or two unit embodiment, isolation of the antenna operating at the same frequency is critical. Therefore, to improve isolation, isolation measurements can be taken, for example, by transmitting a known signal at a known time from one unit and measuring the known signal on the other unit, or in the single unit case, from one antenna to the other antenna. It will be appreciated that the transmission of the known signal can be cleared for transmission on the licensed band or can be transmitted freely on an unlicensed frequency band. The degree of isolation can be displayed such as using a series of LEDs or the like, or a single LED can be illuminated when the isolation is acceptable. In such a way, an installer can move or rearrange the units, or the donor and non-donor antennas in a single unit repeater case, until a desired degree of isolation is achieved as determined by viewing the indicator.

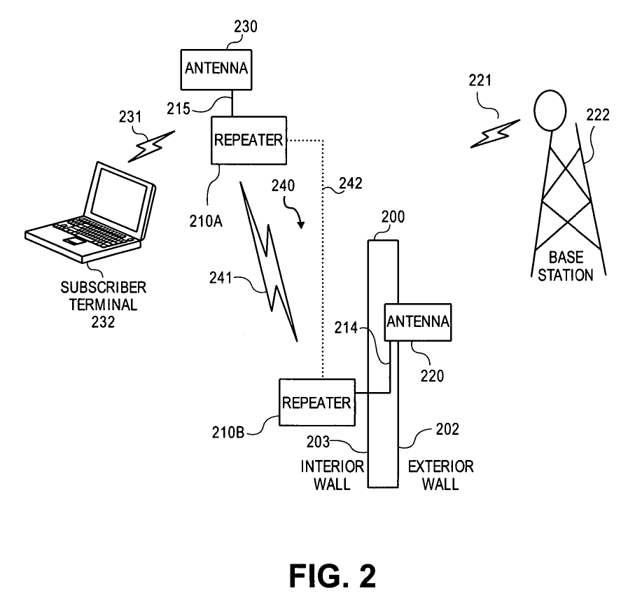

To better appreciate the operating environment of an exemplary repeater or repeater system in accordance with various exemplary embodiments, reference is made to FIG. 2. A base station 222 operated, for example, by a service provider of an 802.16, TDS-CDMA, PHS based system or the like, can communicate with a subscriber terminal 232, which may be located, for example, inside a building. A directional antenna 220 can be located on an exterior wall portion 202 of wall 200 such as in a window, on an external surface or the like and can be coupled through link 214 to a non-frequency translating repeater 210. Packets transmitted between the subscriber terminal 232 and the base station 222 can be repeated in a manner to be described in greater detail hereinafter.

It is important to note that in considering aspects of the physical structure of the repeater 210 some underlying assumptions about the system can be made. In the present discussion repeater 210 is assumed to operate in an environment consisting of a single base station and a single subscriber terminal 232 although it will be appreciated that in some embodiments, multiple subscribers and/or base stations can be included. The frame duration, receive/transmit transition gap (RTG/TTG) to be described in greater detail hereinafter, and the percentage of time allocated to downlink subframes with respect to the length of the frame are known in advance, and in some embodiments, variable frame duration may be possible to accommodate. In a typical session, the expected frame duration is 5 ms, the RTG/TTG gaps are expected to be from around 80-800 μs in duration. A fixed split is expected between the uplink and downlink subframe portions of the frame and a fixed frame duration is specified. Notwithstanding such assumptions, the repeater 210 will be required to autonomously synchronize with start timing of the frame in a manner to be described hereinafter. In addition, the UL/DL subframe relation may change from time to time and the repeater must adapt. Further, for example in accordance with an exemplary 802.16 based embodiment, an operating channel or multiple synchronized channels in the 2.3 to 2.4 GHz transmission band, such as an 8.75 MHz, 10 MHz, or the like operating channel will be known by the service provider and can be set manually at the repeater 210 such as using a control terminal or the like. In the case of WiBro, three synchronized channels may be repeated simultaneously resulting in a total of 30 MHz of repeated bandwidth.

It will be appreciated that repeater synchronization as will be described in greater detail hereinafter can be conducted to ensure that the repeaters are operating in compliance with the timing requirements for the 802.16 protocol. An RSSI method as will be illustrated and described hereinbelow can use power detection, correlation, statistical signal processing or the like.

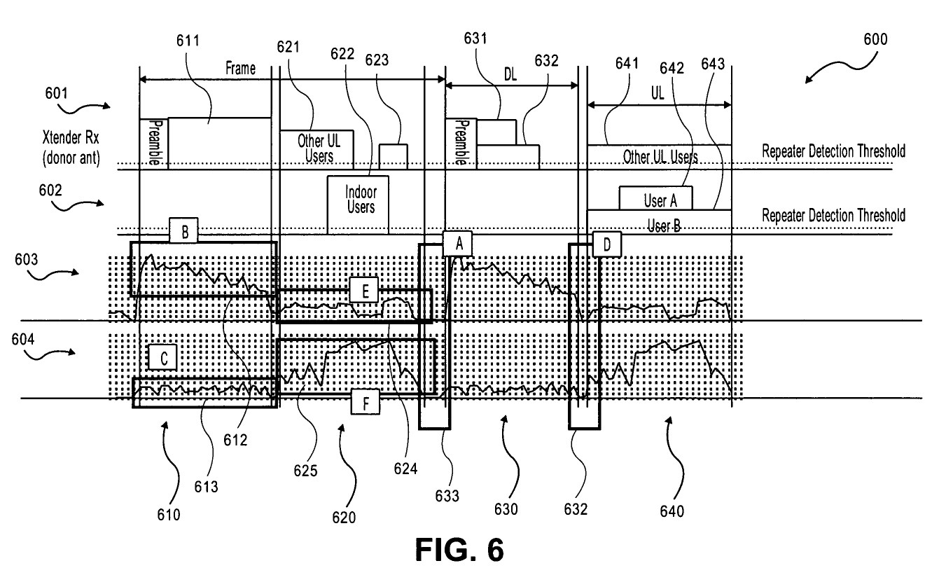

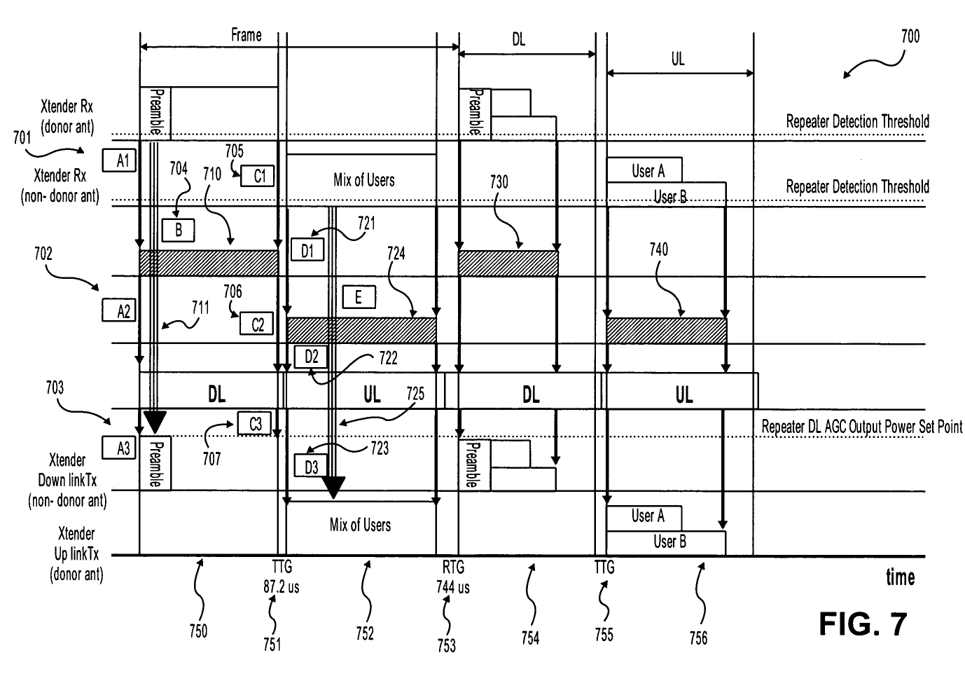

Further, in accordance with an exemplary 802.16(e) based embodiment, such as a “WiBro” embodiment, a typical base station 222 can support a number of frequency subcarriers up to 1024 made possible through orthogonal frequency division multiplexing (OFDM). Channels can be coded and interleaved prior to transmission using, for example, inverse fast Fourier transforms (IFFT). The subcarriers provide a communication link between the base station 222 and a plurality of subscriber terminals 232. For each connection established within a 802.16 system, the uplink and downlink operate on the dedicated uplink subcarriers and downlink subcarriers occupying different time slots as will be described in greater detail in connection with, for example, FIG. 6 and FIG. 7. It should also be noted that multiple subscribers may simultaneously operate on different subcarriers within the same timeslot. Further, multiple base stations (BS) may use the same technique to allow operation on the same timeslots and channels but using different subcarriers.

As noted, an LED indicator will be able to visually notify when proper synchronization of the frame timing has been achieved, if required. Further, a series of LED indicators, for example of a different color, can be provided to show relative signal strength to aid in placement of the antenna and/or the repeater, and proper isolation at the donor and non-donor antennas. As noted above, a RS-232 connector may be provided for hook-up to a control terminal such as a laptop computer with repeater configuration software driven by a graphical user interface (GUI). The configuration software will be able to configure, for example, the operating channel or channels, the frame duration, and can graphically observe key parameters of the repeater in operation. Once such parameters are determined, or once a scheme for application of certain values under certain conditions is determined, such operating control can be delegated to a microprocessor or the like with an operating program. The microprocessor/controller with associated software and/or firmware can then be used for parameter control in production repeaters, which may be pre-configured in manufacturing with the above noted network information.

In accordance with various embodiments, the TDD format, for example, as specified in the IEEE 802.16d/e orthogonal frequency division multiple access (OFDMA) (TTA-PI Korea) standard, should facilitate the development of an exemplary non-frequency translating repeater for commercial use in global markets. Since the uplink and downlink frames will be synchronized between various base stations of a given system, there is little risk of base station transmissions occurring at the same time as subscriber terminal transmissions. Synchronization and the use of sophisticated BS to SS power control techniques serve to mitigate problems such as the near-far effect and the fact that a typical base station 222 may be transmitting with a significantly higher effective isotropic radiated power (EIRP) level than the subscriber terminal 232.

To accomplish TDD repeating, aside from the required signal amplification, the only modification to the radio signal by the repeater 210 is the addition of approximately 1 μs of propagation delay. Since the additional delay of 1 μs is constant, symbol synchronization at the subscriber terminal 232 or the base station 222 is not a problem. The subscriber terminal 232 may receive both the signal from the base station 222 and also the repeater 210 with negligible effect. Given the cyclic prefix time (CP) for an exemplary 802.16 configuration, the additional delay is relatively nominal, and the OFDM subcarriers should remain orthogonal when the direct and repeated signal is received.

In accordance with some protocols, such as 802.16, the subscriber terminal 232 may periodically receive an OFDMA Power Control Information Element containing an 8-bit quantized signed value indicating a change in power level in 0.25 dB increments as will be appreciated. Because of the likelihood of power control associated with the subscriber terminal 232, the automatic gain control setting of the repeater 210 needs to be held to as constant a level as possible between the UL and DL. Any gain provided to the “input” antenna of the repeater 210 needs to be passed through to the power amplifier in a consistent manner. In the case of 802.16(e) WiBro, a specific power control method as discussed and described herein is preferably used.

It will be appreciated that with OFDMA, multiple users and base stations can be receiving or transmitting simultaneously on different subcarriers. The number of subcarriers allocated to each user and the total number of subcarriers that are being used for user traffic are variable from frame to frame. Accordingly, some variation may occur in received power levels at the antenna input of the repeater 210 as not all subcarriers will be allocated during every frame. However, due to the averaging created by a large number of active users, and the operation of the AGC loop in comparison to the duration of a frame, frequency domain multiplexing of users should not be a significant problem for the repeater 210. The present invention further mitigates any issues by allowing the gain provided on the DL by the AGC to be applied in the UL to maintain a “reciprocal channel” allowing both open and closed loop 802.16 power control to operate transparently.

In accordance with 802.16(e) and WiBro, several types of power control are defined to implement closed loop and open loop UL power control. Some of are mandatory and some are optional. Both open loop UL power control and closed loop UL power control rely on the assumption that the path loss on the DL is equal to the path loss on the UL with some adjustments to compensate for non-TDD mode of operation. For TDD mode of operation, path loss reciprocity holds more closely than for FDD/TDD mode.

For power control in TDD modes of operation, a preferred approach is to attempt to maintain a total reciprocal path loss on the entire down link and entire uplink such that reciprocity of path loss is maintained as closely as possible. Where the path loss is not maintained due to various practical constraints, the closed loop power control mechanisms will make offset adjustments to compensate for the required differences in the UL/DL. It should be noted that the differences in path loss may be due to localized interference on one link requiring additional received power to overcome. The differences may also be due to limitations in the output power or sensitivity of the repeater.

Thus the preferred approach to power control is as follows. On the DL, the gain will be set during the preamble and held constant for the duration of the DL sub-frame. The gain will be set such that a target output power is achieved according to a typical AGC approach to setting constant output power, with the exception that the gain is “frozen” after initial setting is completed. The gain, which is applied to the DL sub-frame, is stored and retrieved for use on the UL. In addition to the above described procedure, the repeater output target power set during the DL gain setting operation may be adjusted by an offset to influence the way the SS gain procedure will operate, and thus influencing the transmit power levels to some extent.

For LL gain control, the gain applied to the DL transmissions, which was stored as noted, is retrieved and applied in connection with the UL, regardless of the received power or transmit power unless specific limits are exceeded. To conduct UL output power management, if the signal received from the SS is too strong, such that after applying the DL gain in connection with the UL repeater mode, the gain must be reduced by an amount DELTA, the value DELTA should then be included as an offset to the DL output power set point. The offset will be reflected in the DL AGC function as an increase in output power, which will influence the power control in the SS to reduce the TX power during UL operation, as is typical in open loop and closed loop power control methods as specified in 802.16(e).

For UL receive power management, in contrast to the above example, if the repeater is receiving a low signal level from the SS, an offset to the DL AGC may be subtracted as a-DELTA from the DL output power set point decreasing it such that the open loop power control will act to increase the output power from the SS resulting in a stronger signal being received at the repeater from the SS during UL operation.

In connection with the application of a DELTA or offset to the DL Output power, the offset to the downlink power control can be referred to as UL_OFFSET_TO_DL_TXPOWER_SP. It should be noted that power control in connection with 802.16(e) is described in section 8.4.10.3.1 (closed loop power control), and section 8.4.10.3.2 (open loop power control) Part 16: Air Interface for Fixed Broadband Wireless Access Systems of IEEE Std 802.16-2004.

As will be appreciated by one of ordinary skill in the art, the repeater 210 may apply a fixed gain to the inbound and outbound signals and may operate on the same frequency on both the uplink and downlink time periods in duplex mode. To provide uplink power control, the uplink is set according to a measured power level on the downlink. Such a configuration is important to reduce gain adjustments caused by the reaction of, for example, a base station to sensed downlink path loss that would be generated by systematic differences in the gain levels that come about as a result of factors such as placement of the repeater units. If the repeater unit that is in communication with the subscriber is placed such that a strong signal is received from the subscriber, it may report that a lower signal level is required, while the repeater communicating with the base station may have a different repeating environment where lowering the transmit power would be undesirable. Therefore, by matching the uplink and downlink power levels, the perceived path loss can be minimized reducing the chance of saturation of the power amplifiers due to power control settings that fall out of range. In accordance with a preferred embodiment, on the downlink, the detection of the power level can be determined during an initial part of the downlink packet, such as the preamble, and then “frozen” for the remainder of transmission of the downlink packet. The power level for the subscriber terminal 232 can be set to the same power level on the uplink thus minimizing the perceived path loss and establishing path reciprocity. In other words the downlink gain is manipulated such that the transmit power level on the uplink and the resulting received power level at the repeater unit servicing the subscriber are controlled. Thus, automatic gain control is used on the downlink to set output power from the repeater and the gain setting is applied to the uplink independent of the repeater uplink output power within limits.

It should be noted that if a portion of the output signal reaches the input either externally or internally with sufficient gain, an input to output oscillation condition, similar to that which can occur in certain types of CDMA repeaters, could occur, significantly reducing system performance. The amount of internal and external isolation correspondingly limits the amount of amplification the repeater 210 can provide. Thus, providing 75 dB of gain requires that antenna to antenna isolation of the repeater 210 and the antenna to antenna isolation of the particular installation be 10 dB above the maximum applied gain or 85 dB of isolation. To achieve the desired internal isolation, careful attention to leakage and EMI related issues must be taken into account in the circuit design particularly in the input signal and feedback path design. To achieve the desired external isolation, it is assumed that, as a minimum, a directional antenna will be used for, for example, the link 221 to the base station 222. It can also be assumed that the antenna 220 serving the link 221 to the base station 222 will be on the exterior wall 202 of wall 200 with as close a line of site connection to the base station 222 as possible. The link 231 from the repeater 210 to the subscriber terminal 232 is assumed to use an omni directional antenna as would typically be installed inside of a building or structure. If signal oscillation continues to occur, the repeater 210 can detect it and reduce the amount of gain to the link 231 until better antenna to antenna isolation is achieved, either by further separating the antennas, or by optimizing there orientation or placement.

For proper TDD operation, for example in the exemplary PHS and the exemplary 802.16 embodiments, the repeater 210 needs to determine whether to amplify the signal in the uplink direction or the downlink direction, by determining the start and end timing of the uplink and downlink subframes associated with the relevant TDD protocol. For example, on the downlink subframe, the signal arriving at the directional antenna 220 facing the base station 222, also referred to as the donor port, needs to be amplified and output at directional antenna 230. On the uplink subframe, the signal from subscriber terminal 232 arriving at directional antenna 230 needs to be amplified in the opposite direction and output at directional antenna 220 to the base station 222.

It should be noted that in accordance with 802.11 TDD repeating, the presence of a packet on one of the two antennas is detected and the direction of amplification is dynamically changed. Other techniques for TDD amplification such as TDD remote amplifiers can clip the beginning of a packet due to the amplifier being disabled prior to detection of the presence of the wave form. If the preamble of the waveform is not clipped, 802.11 TDD repeaters may be cascaded in series for deeper in-building penetration. While cascading and associated detection techniques work well for 802.11 systems, some form of uplink/downlink synchronization must be employed where multiple subscribers may be transmitting. Multiple subscribers may confuse the repeater 210 if more system information is not used.

In accordance with various exemplary embodiments, several methods can be used to determine TDD framing. Thus the repeater 210 can use a number of strategies to accurately determine the direction in which the signal amplification should take place. The techniques described herein are not affected by timing differences due to factors such as the propagation distance from the repeater 210, and unwanted signals arriving from adjacent cell sites which may arrive after the end of the subframe in which they were transmitted.

The methods for determining amplification direction can involve a combination of metrics such as using first signal arrival to gate and latch the repeater 210. It should be noted that since, through normal system operation in accordance with various protocols, the base station 222 will decide to advance or retard transmission from different subscribers so that packet transmissions arrive at the same time, the repeater 210 can be configured to latch on the first arriving signal and ignore any other channel detection for that packet.

It will be appreciated that statistical analysis of received power levels as a function of time can also be used to determine amplification direction. It is expected that during the downlink subframe, the received power into the directional antenna 220 facing the base station 222 will have distinct properties. Known transmission features associated with the signal from the base station 219 may further be used for, or to assist in synchronization.

Additional features associated with timing can include defined gaps and control channel slot consistently appearing on the downlink on a periodic basis such as FCH, DL-MAP, and UL-MAP data. Thus, the consistency and periodicity can be used with known system information such as uplink and downlink slot parameters to identify and synchronize with the timing of the base station.

Feature detection, as described above, can include detailed statistical analysis of the signal from the base station 222 to identify known features and timing characteristics of the signal. Accordingly, three exemplary steps can employed by the repeater 210 for determining the direction of amplification of the wireless signal. First, the location of the transmit transition gaps and the receive transition gaps (TTG/RTG) as will be described hereinafter can be determined in part by monitoring the directional antenna 220 during initialization. Second, the start timing and the duration of the downlink subframe within the 5 ms IEEE 802.16 frame can be determined. Lastly, the transmit and receive timings between the uplink and the downlink subframes can be adjusted at a rate of once per frame.

In some 802.16(e) systems, modem based synchronization is used to explicitly receive signaling information about the timing of the uplink and downlink subframes and apply such information in synchronization. However, such systems are costly and complex. The present system, by providing synchronization through the use of power detectors, correlators, and the like, greatly reduces cost and complexity by eliminating the need for an expensive modem.

In accordance with one exemplary embodiment, the repeater 210 looks and functions in a manner similar to cdma2000 RF based repeaters but with specific differences as will be described and appreciated by those of ordinary skill. A typical repeater system as described above, consists of an outdoor directional antenna with a gain of perhaps 10 dBi with a coaxial cable several feet in length connected to an indoor repeater module. The repeater module will be powered by an external DC power supply. The repeater will also be connected to an indoor omni directional antenna with a gain of perhaps 5 dBi amplifying the signal to the various rooms of a subscriber residence, work space or the like. The indoor antenna may also be directional as long as the proper antenna to antenna isolation is achieved.

It will be appreciated that a technical support person may be necessary to mount the directional antenna 220 to the exterior wall portion 202 of the wall 200 of the building and to run the cable to the inside of the building. However, no special configuration will be required for the set-up of the indoor repeater, and the residential customer could likely orient the indoor antenna to a particular liking without assistance. It should also be noted that the personal repeater may contain one or more LEDs to indicate RSSI levels, antenna isolation, synchronization, or the like, in order to help with the placement of the repeater 210, the orientation and placement of the directional antennas 220 and 230, and to indicate when the repeater 210 has properly synchronized to the timing of the TDD uplink and downlink subframes.

Alternatively, as shown, repeater 210 can include two units, such as repeater unit 210a and repeater unit 210b. The units can be coupled using a link 240 which can be a wireless link 241 or a wired link 242 as described above in connection with FIG. 1.

In accordance with other exemplary embodiments, non-frequency translating repeater service is aimed at providing high capacity Internet service in service areas previously difficult to access such as subway service or in-building service. For example, an in-building repeater could be configured as a small indoor unit with one antenna for outdoor or near outdoor placement, and another antenna for indoor placement, for example, as described hereinabove. Other repeater models will be more suitable for self installation.

It is envisioned the exemplary repeaters will have specifications similar to existing repeaters, such as for IS-2000 systems. The repeaters can take various forms including for example, a same frequency indoor repeater, an outdoor infrastructure repeater, which is a high power repeater used to fill in poor or problem coverage areas in a outdoor installation such as in an alleyways or to selectively extend coverage beyond the current coverage areas. The outdoor infrastructure repeater can be deployed on top of buildings, on cell towers, or the like. Further an exemplary repeater can include an indoor distribution system where significant distances must be spanned between the repeater and the antenna coupled to the base station for use in subways and parking garages. Still further, an exemplary repeater can include a fiber optic repeater system with relatively short fiber distances to achieve “deep” in-building coverage. Long fiber optic distances however, might cause system level problems with the operation of the repeater systems described herein depending on factors such as latency and the like.

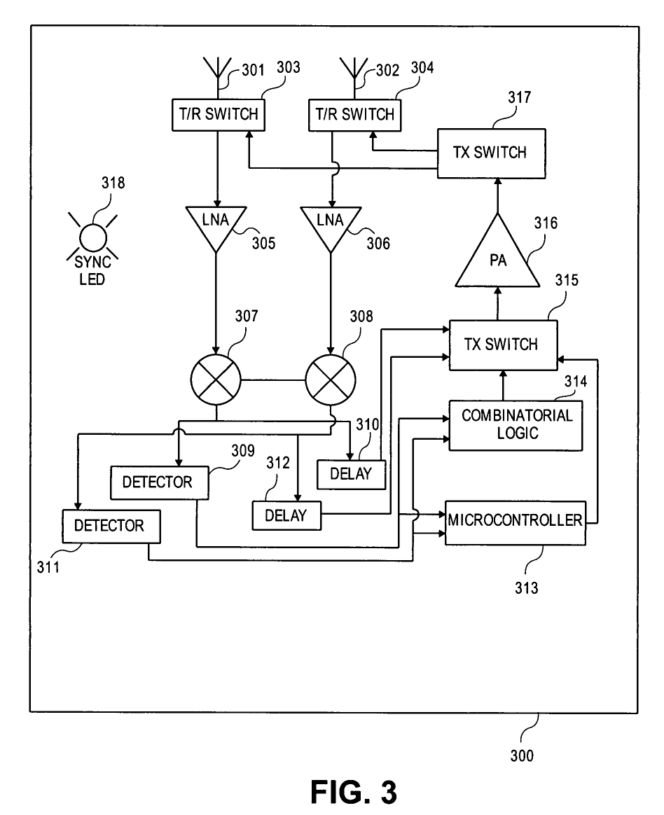

A block diagram of an exemplary repeater 300 is shown in FIG. 3. An antenna 301 and an antenna 302 are coupled to a Transmit/Receive (T/R) switch 303 and 304 respectively. Initially, each of the T/R switch 303 and the T/R switch 304 is set to feed the signal from each of the antenna 301 and the antenna 302 into the corresponding low noise amplifier (LNA) 305 and the LNA 306. The amplified signal is then translated down in frequency using a frequency mixer 307 and a frequency mixer 308 and can further be passed into a corresponding signal detector such as a detector 309 for antenna 201 and a detector 311 for antenna 302. The first antenna for which a signal is detected is set as the input antenna by configuration of one of the T/R switch 303 or the T/R switch 304, and the other antenna is set as the output antenna again, by configuration of the other of the T/R switch 303 or the T/R switch 304. It should be noted that in a typical application such as in a 802.16 application, the detection process takes about 500 ns, and the delay in setting up the transmit switch is about 200 ns. A transmit switch 315 passes the signal from the input antenna, delayed by a delay amount added in one of a delay element 310 or a delay element 312, into a power amplifier 316 which feeds the amplified signal, through the operation of another transmit switch 317, into one of the antenna 301 or the antenna 302 designated as noted above as the output antenna. It will be appreciated that the amount of delay should not exceed or even be close to the timeout value associated with the protocol. Further, if the TDD protocol requires synchronization as is the case for 802.16(e), the detection delays may not need to be compensated for. A microcontroller 313 and a combinatorial logic circuit 314 can be used to increase the reliability of the detection process and to perform additional procedures such as system maintenance, control, and the like as will be appreciated by one of ordinary skill in the art, and to execute certain software to enhance, augment, or control operation of the repeater 300. It will also be appreciated that in some embodiments, at least one of the connections between the antenna 301 and 302 can be coupled to the exemplary repeater module using fiber optic cables.

It should further be noted that the detector 311 may be used in itself to enable repeating or may be used in combination with the synchronized uplink or downlink frame timing. Alternatively, the detector 311 may be only used to maintain uplink and downlink synchronization. For instance, once synchronized, the detector 311 on a given antenna will cause repeating from that antenna to the other antenna. However, if the detector 311 detects a signal in a timeslot not defined as a valid repeater slot for the given antenna, it would not repeat the information.

NMS as mentioned hereinabove, for the repeater 300 can be implemented in certain cases such as in connection with the in-building distribution repeater and the infrastructure repeater. However, due to the additional cost of the modem, microprocessor, and memory, it is not expected that there will be a NMS option for the typical, personal use type repeater. NMS can include remote gain adjustment, remote firmware upgrades and can be developed with coordination from the customer premise equipment (CPE) vendor.

With reference again to FIG. 3, it should be noted that in accordance with exemplary embodiments, if required, the repeater 300 can delay the input radio frequency signal by an amount equal to the time it takes to determine the direction in which signal amplification needs to take place, for example, as described above. All of the transmit and receive switches such as T/R switches 302, 303 and TX switches 315, 317 are set to the correct direction just prior to the arrival of the delayed input signal into the PA 316, and hence no portion of the signal is ever clipped. The direction of amplification will be known based on the defined timeslots and the synchronized framing. Thus, the above described techniques may be used in combination to enable repeating. For example, synchronization AND detection on a specific antenna port must be present to enable repeating. In other words, repeating will be enabled only when a signal is detected on a given antenna port when it should be present, such as during a valid uplink or downlink time slot in accordance with the synchronization.

An active RF repeater is advantageous in comparison to a store-and-forward repeater because of improvements in delay, improvements in throughput, and reduction in complexity. Further, the integrity of data security schemes is maintained with an RF based repeater since no encryption keys are required resulting in reduced complexity and management. The delay of an RF repeater is under one micro-second and potentially several hundred nanoseconds, whereas the delay of a store-and-forward repeater is larger than the frame time, which is 5 ms for IEEE 802.16. An increase in delay of this magnitude is not tolerable for many delay sensitive applications. It will be appreciated that a bottleneck in the bit rate of the store-and-forward repeater arises in that the achieved bit rate is limited by the bit rate of the slowest point-to-point link. Since it is not always possible to place the repeater exactly half-way between the subscriber and base station, the improvement in throughput and range may be quite limited. Also, as indicated in Table 1, the improvements in the bit rate are the greatest for the smaller block sizes, and diminish for the larger block sizes. Because each packet needs to be sent twice, in the case of R=3/4 16-QAM and 64 QAM modulation the store-and-forward repeater may reduce the cell throughput. Lastly, a store and forward repeater is inherently more complex because of the additional processing which must take place in order to recover and retransmit the packet adding to the price of the repeater and increasing its power consumption. Practical limitation in the protocols related to security, Quality of Service (QoS), and cost of installation, and network management can prevent the widespread adoption of store and forward repeaters.

As noted below, Table 1 shows receiver SNR and uncoded block size for the IEEE 802.16 Signal Constellations, and block size improvement ratio with 9 dB SNR improvement.

| | Coding | Receiver | Uncoded | Block Size |
|---|---|---|---|---|
| Modulation | rate | SNR (dB) | block size | Improvement Ratio |
| QPSK | ½ | 9.4 | 24 | 3 |
| QPSK | ¾ | 11.2 | 36 | 2 |
| 16-QAM | ½ | 16.4 | 48 | 2.25 |
| 16-QAM | ¾ | 18.2 | 72 | 1.5 |
| 64-QAM | ⅔ | 22.7 | 96 | 1.125 |
| 64-QAM | ¾ | 24.4 | 108 | 0 |

It should be noted that if multiple simultaneous transmissions take place in different OFDM sub-channels, as permitted by, for example, IEEE 802.16 OFDMA, which permits multiplexing to take place in both the time and frequency domain, the transmissions to individual users can occupy different sub-carriers simultaneously. Since the exemplary repeater will synchronize to the beginning of the uplink and downlink subframes regardless of how many users are transmitting in these subframes, the repeater will be able to amplify the multiple simultaneous transmissions without any problems. The different number of occupied sub-carriers may however cause a fluctuation in the AGC input power, but the gain control algorithm should provide a sufficient accuracy margin.

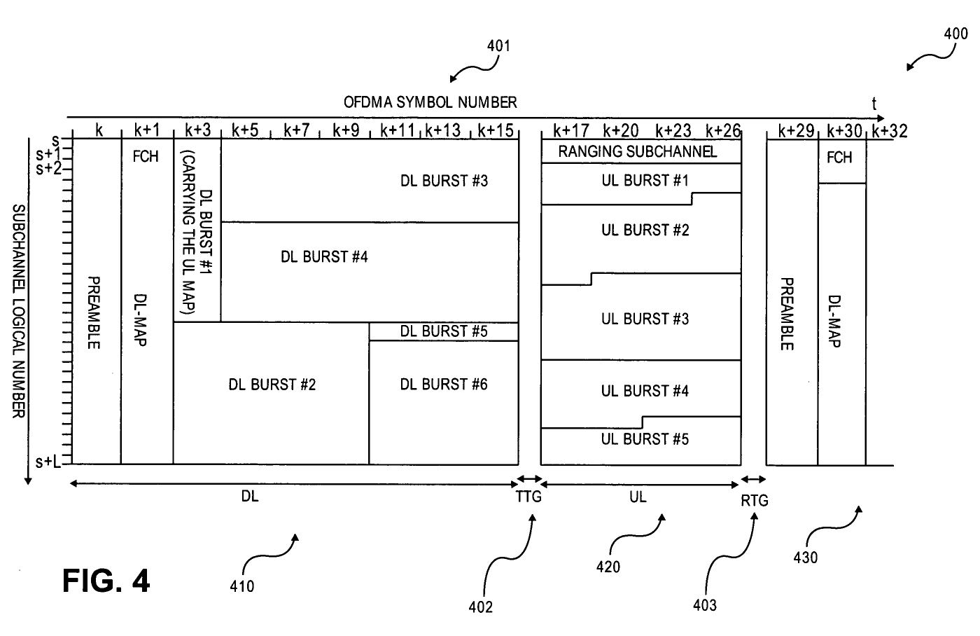

For a better understanding of the structure of a typical frame scenario 400 in accordance with 802.16(e), reference is made to FIG. 4, in which the structure of the logical subchannels is plotted against time and corresponding OFDMA symbol number 401. Within the downlink (DL) frame structure 410 and uplink (UL) frame structure 420, various frame components are shown including the preamble and DL map sections in DL frame structure 410 and various UL burst sections in the UL frame structure 420 as will be appreciated. The UL frame structure 420 and the DL frame structure 410 are separated in time by transmit transition gap (TTG) 402, while the end of the frame and the beginning of the next frame portion 430 are separated by a receive transition gap (RTG) 403, whose placements are also shown. It should be noted that the DL frame structure 410 consists of a preamble section, a DL map, an UL map, and several data regions that can be considered as a two-dimensional resource allocation. The first resource dimension is the group of contiguous logical sub-channels and the second resource dimension is the group of contiguous OFDMA symbols 401. The DL frame structure 410 is divided into data regions or “bursts.” Each burst is mapped in time with the first slot being occupied, for example, by the lowest numbered sub-channel using the lowest numbered OFDMA symbol. Subsequent slots can be mapped in accordance with increasing OFDMA symbol index. The edge of the burst signifies a continuation of the mapping in the next sub-channel and a return to a lower OFDMA symbol index. In a typical OFDMA frame, there may be 128 sub channels.

The UL frame structure 420 includes burst regions occupying the entire UL sub-frame. Within the UL bursts, slots can be numbered beginning with the lowest sub-channel corresponding to use of the first OFDMA symbol. Subsequent slots are mapped according to an increasing OFDMA symbol index. When the edge of the burst is reached, the mapping is incremented to the next sub-channel returning to use of the lowest numbered OFDMA symbol for the UL “zone.” The UL bursts consist of contiguous slots. The UL frame structure can be regarded as uni-dimensional in that a single parameter, such as burst duration, is required to describe the UL allocation significantly reducing the UL map size.

It will be appreciated that the above noted configuration may impose buffering requirements since UL and DL bursts may span the entire duration of the sub-frame. For example, UL bursts span the entire UL frame while DL bursts may span the entire DL frame. In both the DL frame structure 410 and the DL frame structure 420, a burst may span the entire bandwidth or, in other words, the entire number of sub-channels. A maximum buffer size therefore should be equivalent to an entire sub-frame.

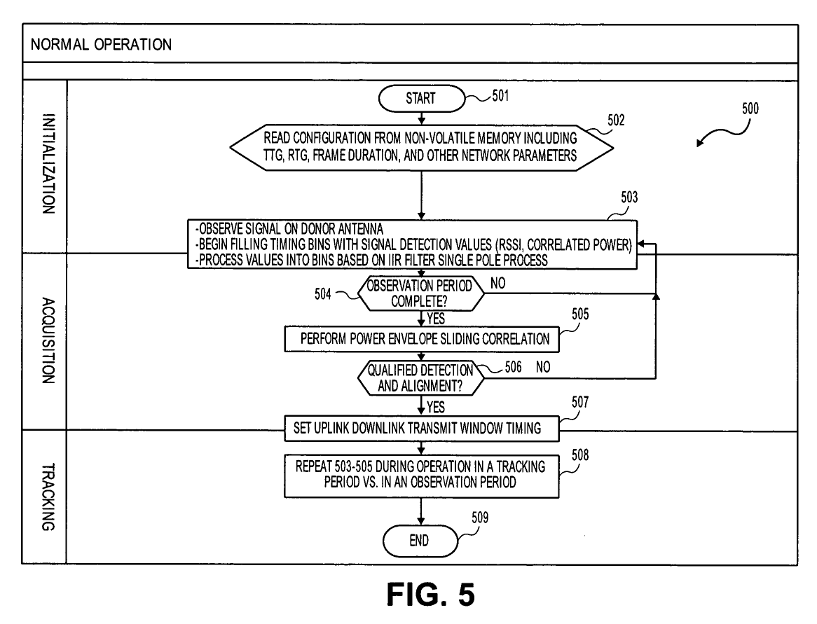

To better understand the operation of an exemplary TDD repeater in accordance with various embodiments, a flow chart of an exemplary procedure 500 is presented in FIG. 5. Procedure 500 includes the operation of, for example, synchronization in accordance with the invention. After start at 501, a configuration can be read from a memory such as a non-volatile memory at 502. The configuration can include the time duration of the transmit transition gap (TTG) and the receive transition gap (RTG), the frame duration, and any other network parameters for operation. Once repeater operation begins, at 503, the signal on the donor antenna can be observed and statistical bins can be filled with values associated with the detected signals such as received signal strength indicator (RSSI) level, correlation level, power level and the like. The signal can be observed during, for example, an observation period that can be established having a duration of from one to several frames or many frames depending on factors such as the reliability that is desired. A observation period with a duration of, for example, 30 seconds or thereabouts can produce acceptable results in many situations. The values accumulated in the bins can be processed in accordance with a single pole infinite impulse response (IIR) filter process using a processor or controller such as a high performance processor, signal processor, or the like as will be appreciated. It should be noted that the specific bin to be filled will increment for each power measurement. The number of bins will correspond to the duration of the 802.16 frame and the bins are cyclically updated. The values input to a specific bin will occur at the frame rate and use a weighted average, IIR filter or other common technique known to those of skill in the art.

If the observation period is determined to be complete, for example, at 504, a power envelope sliding correlation or windowing function can be performed at 505 on the bin contents to determine where the timing windows exist based on statistical analysis. If the observation period is not completed, the bins will continue to be filled during the observation period. The contents of the uplink and downlink frame windows can be qualified at 506 and if determined to be properly qualified and aligned, based on known parameters such as the frame rate and the like, the downlink transmit window timing can be established at 507. It will be appreciated that the procedures of steps 503-505 can be repeated during operation in a tracking period at 508 rather than in an observation period to maintain synchronization and alignment. While the procedure is indicated as ending at 509, it will be appreciated that the procedure can be invoked whenever repeater start-up is performed, can be performed periodically, or can be performed simply whenever recalibration or adjustment in synchronization is desired. Such choices for repeating the synchronization procedure and other operations and parameters, can be embodied for example in a software or firmware configuration or can be partially or totally implemented in an integrated hardware device such as a integrated circuit chip or the like as will be appreciated.

An exemplary synchronization scenario 600, in accordance with various embodiments, can be better understood with reference to FIG. 6. The received signal strength intensity (RSSI) vs. time on a donor antenna 601 and non-donor antenna 602 is shown therein in plots 603 and 604 respectively. It should be noted that the duration of, for example, TTG and RTG and possibly other timing relationships are not shown to scale for purposes of illustration. It will be appreciated that information gained from, for example, the various steps and procedures described above in connection with FIG. 5, can be used to modify the detection thresholds in the up/down transmission selection process of an exemplary repeater amounting to an a priori detection algorithm where the uplink and downlink detection thresholds are dynamically modified based on the known synchronization of the up and down link slots. During the TTG and RTG which are typically specified to be at least 87.2 μs and 744 μs respectively in duration, there is no air activity on either the uplink or the downlink. Simple RSSI detection, or a windowing function associated with, for example, the RSSI can be used to identify the location of these gaps.

In the diagram, a typical frame is shown, such as for example, the frame shown and described in connection with FIG. 4. During a downlink (DL) interval, such as DL interval 610, DL transmit windows such as DL window 612 and 613 can be established and during an uplink (UL) interval 620, UL transmit windows such as UL window 624 and 625 are shown to provide synchronization for the receipt and transmission of information in compliance with the timing requirements of the 802.16(e) protocol. It is important to note that the timing windows must be tracked to ensure that alignment and synchronization are maintained during repeater operation. As previously noted in connection with FIG. 5, detection values can be placed in bins that are represented by the area of dotted columns in the UL intervals 610 and 630 and the DL intervals 620 and 640. Each column or bin represents a signal sample at an appropriate fraction of the desired resolution. In the present example, a 10-20 μsec sampling interval should be adequate to accurately determine the timing of the signal edges during DL, UL, RTG and TTG intervals of plots 603 and 604, which are represented in the figure as areas B 612, E 624, A 633 and D 632 for the donor antenna 601 and areas C 613, F 625, A 633 and D 632 for the non-donor antenna 602. As discussed and described above, the bins are updated in a cyclic fashion at a period equal to the frame duration during, for example, an observation period or the like.

As will be appreciated the UL/DL timing can be tracked, that is the values can be determined by performing one or more of the following: using a preamble correlator, a matched filter, or a simple RSSI value. Further, known TTG timing, frame timing, RTG timing can be used as a parameter in evaluating the bin contents or the like. Averages, histograms, thresholds, or other statistical approach can be used to determine or refine a “slot” or symbol occupancy for a fraction of a frame timing, and most likely a fraction of a symbol or slot timing.

In accordance with other embodiments, the rising edge of the DL TX sub-frame content 611, shown at region B 612 in plot 603, can be tracked, and is always occupied with preamble, FCH, DL_MAP message and data contents. The falling edge of the DL TX sub-frame content 611 can also be tracked although it is not guaranteed to be occupied with content at all times and tends to merge with the transmission gap. The rising edge of the UL sub-frame can be tracked with the corresponding bin being filled by user data 621, user data 622, or user data 623, in other words any subscriber data sent on either the donor antenna 601 or non-donor antenna 602. It will also be appreciated that other activity on the donor antenna 601 and the non-donor antenna 602 are shown, for example, as user data 631, 632, 641, 642 and 643.

In other embodiments, or to augment existing embodiments, the RTG gap 633 and/or TTG gap 632 can be observed between successive transmissions on the donor antenna 601, or the donor antenna 601 and non-donor antenna 602. It should be noted that if no subscriber is inside a structure where the repeater configuration is located, any outdoor subscriber transmission may be observed on the donor antenna and the TTG or RTG gaps observed and used for synchronization.

Further, the average RSSI over several bins during each of the zones B 612, C 613, E 624, F 625, and A 633 and D 632, can be integrated and compared to a detection threshold shown in FIG. 6 as dotted lines. Multiple metrics from multiple integrations can be used to make the final timing and detection decisions and may include TTG, RTG, Preamble correlations, integrated DL sub frame power, and the like. Consider an example for DL timing where averaged bins for DL subframe duration are integrated. A value of 10*integrated RTG gap can then be subtracted and the timing of the resulting “envelope matched filter” can be slid by 1 bin, producing a metric for each time alignment with incremental bin offsets. The time alignment with a maximum value can be chosen as the correct timing alignment and the UL/DL TX enable window can be adjusted accordingly.

Alternatively, timing may be based on a preamble/symbol correlation with RSSI used for determining the UL/DL sub-frame ratio in a manner similar to that described above. As an alternative to averaging the RSSI or correlated values in each bin, a non-linear or linear weighted combination of the values may be used to produce the per bin value to be used in the envelope matched filter analysis techniques. A simple example of an envelope matched filter can be expressed as Output(bin)=−100*P(RTG)+P(DL-donor)−100*P(TTG)−P(DL-non-donor), where the function P(x) is a integration of the power over a number of pre-processed time bins, and may include correlated power, RSSI power, or the like. Further, the pre-processing may include a simple average, an IIR or FIR filter structure, or a non-linear processing of individual measurements in the respective bins over subsequent measurements and updated at the frame rate. As noted, when the output is plotted as a function of the bin, a “match” in the above described correlation filter will include the peak as representing the best alignment. The alignment associated with the peak will provide the relative adjustment to the timing such that the bin alignment will be expected and such that the DL/UL TX ENABLE window is aligned with the correct bins and UL/DL subframe timing. It should be noted that the foregoing example assumes that the frame time that the UL/DL sub-frame durations, RTG, and TTG are all known.

Accordingly, using the above described procedures and circuits, repeating in various protocol environments can be accomplished where non-regenerative, Physical layer (PHY), TDD type repeating is desired. As illustrated in FIG. 7, a repeating scenario 700 is illustrated where qualified repeating using a synchronized repeated direction enable window and AGC control is used.

By way of various examples shown in the figure, the AGC control in accordance with the invention can be better understood particularly in view of the description provided in connection with FIG. 6. Consider a downlink interval such as a DL 750, for example, from a base station (BS) to a subscriber station (SS) using an exemplary repeater. At A1 701, a signal received at a donor antenna of the repeater exceeds a threshold such as the repeater detection threshold shown in the figure as a horizontal dotted line. A baseband signal 710 at B 704 can be generated in the repeater. At A2 702, the donor antenna signal detection logic can be activated with a logical value indicating detection. At A3 703, a transmission is enabled on non-donor transmitter of the repeater. The transmitter is enabled if (donor signal detect =True) AND (DL TX window=True) meaning the downlink transmit window is established and synchronized and currently active on the DL so that end to end repeating link 711 can be established. Once the transmitter is enabled in accordance with the above, the transmit power for DL can be determined based on AGC procedures. Accordingly, the power set point can be output and the value of the downlink gain DL_Gain can be stored. The power set point in shown in the figure as the horizontal dotted line Repeater DL AGC Output Power Set Point.

To handle the end of the transmission on the DL from the BS to SS via repeater, the following procedure can be used for illustration. At C 1 705, a received signal at the donor antenna is determined to be below the threshold. The end of the baseband signal 710 is reached. At C2 706, the donor antenna signal detection logic becomes deactivated. At C3 707, the transmitter is disabled on the non-donor antenna according to the logic noted above.

Now, consider an LL from the SS to the BS using the exemplary repeater after a TTG 751 of, for example, 87.2 μsec. At D1 721, a signal at the non-donor antenna of the repeater receiver exceeds the detection threshold and a baseband signal 724 is generated. At D2 722, the non-donor antenna signal detection logic is activated with a logical value indicating detection. At D3 723, the transmitter is enabled on the donor antenna according to the following logic. The transmitter is enabled if (non-donor signal detect=True) AND (UL TX window=True). An end to end repeating link 725 is thus established.

Finally, to determine the transmit gain on the UL, the stored DL_Gain from the last DL frame to the uplink is applied. The power on the uplink can be calculated in accordance with Pout(UL)=Rssi(UL)+DL_Gain. Apply the gain to achieve min(Pout, Pout max). If the valued of Pout is greater than the Pout max value, calculate a gain reduction value Gain_Reduction required to reduce the power. The DL output power set point is then reduced by the value Gain_Reduction. If UL detection has not occurred, the DL output power set point can be increased incrementally, but not to exceed DL_Pout_Max. In this way, the LL transmit gain can be maintained within a desirable range by manipulating the DL output power set point. Similar procedures can be followed for the repeating of baseband signal 730 on DL 754 after an RTG 753 of, for example, 744 μsec and baseband signal 740 on UL 756 after a TTG 755, which can be for example, 87.2 μsec as described above in connection with TTG 751.

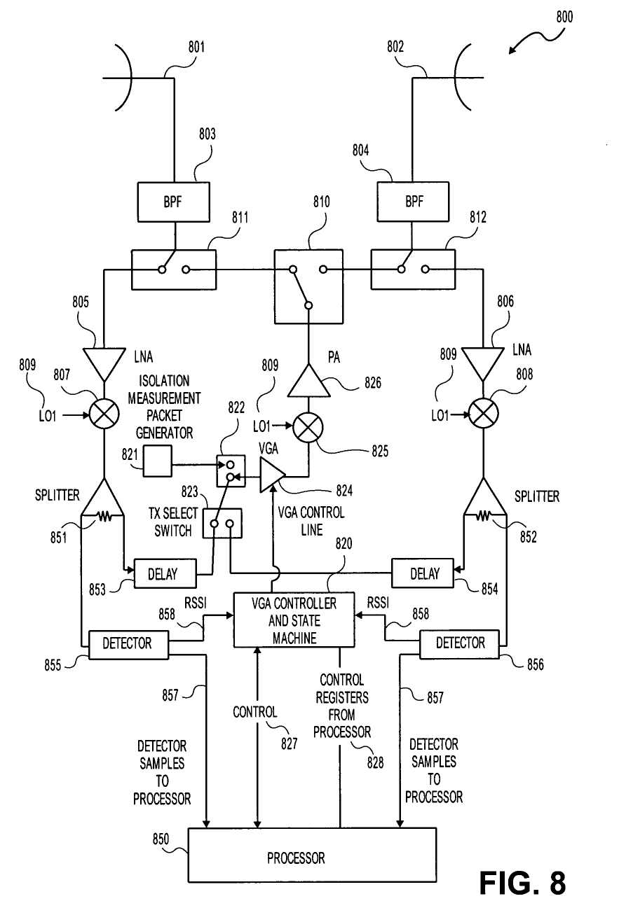

A circuit diagram of an exemplary repeater configuration 800 is shown in FIG. 8. Further to the configuration shown, for example, in FIG. 3, a variable gain amplifier (VGA) controller and state machine (hereinafter “VGA 820”) and detectors 855 and 856 for carrying out various procedures as described herein are shown. Signals can be received and transmitted using antennas 801 and 802, which as will be appreciated can be directed toward various donor and non-donor portions of the repeating environment. Each of the antennas 801 and 802 can be equipped with bandpass filters (BPF) 803 and 804 and antenna switches 811 and 812 for placing the antenna in transmit or receive mode. An antenna switch 810 can direct a transmit signal to one or the other of antenna switches 811 or 812 as will be appreciated. During a reception evolution on antenna 801, the incoming signal, after passing through BPF 803 and switch 811, will be amplified with low noise amplifier (LNA) 805 and down converted in mixer 807, which mixes the received signal with local oscillator frequency LO1 809. The resulting intermediate frequency (IF) signal can be passed to splitter 851 where the signal instances can be passed to delay unit 853 and detector 855. For a reception evolution on antenna 802, the incoming signal, after passing through BPF 804 and switch 812, will be amplified with low noise amplifier (LNA) 806 and down converted in mixer 808, which mixes the received signal with local oscillator frequency LO 1 809. The resulting intermediate frequency (IF) signal can be passed to splitter 852 where the signal instances can be passed to delay unit 854 and detector 856.

When a signal is detected in either of the detectors 855 and 856, samples 857 can be passed to the processor 850 for conducting for example, statistical processing or the like as described hereinabove. The detectors 855 and 856 can also provide RSSI measurements 858, which can be passed to VGA 820 for conducting gain control and transmit power adjustments also as described. Processor 850 can be configured to control VGA 820 through control line 827 which can be a line, a port, a bus or the like as will be appreciated. Processor 850 and VGA 820 can be configured to access control registers that are generally located in the processor 850. VGA 820 can access control registers through line 828, which can be a line, a port, a bus, or the like as will be appreciated. In an exemplary scenario, a signal received on one antenna can be transmitted on the other antenna after a delay period generated, for example, by delay units 853 and 854. Depending on the direction of reception and retransmission, the signal can be directed through operation of TX Select switch 823, switch 822 and VGA 824, which can be controlled by VGA 820 through a control line as will be appreciated. Switch 822 can also be used to insert packets for isolation measurement purposes, from packet generating unit 821. The output of VGA 824 can be passed to mixer 825 for mixing with LO1 809 for upconversion. The output of mixer 825 is directed to power amplifier 826. The transmission signal will be directed to the opposite side of reception through switch 810. For example, if the signal is received on antenna 802, switch 810 will direct the repeated signal to antenna 801 through switch 811

It should be noted that the VGA 820 can be configured with control registers through line 828 containing, for example, the DL power setpoint, the UL MAX power output level, the UL MIN power output level, and the like. The VGA 820 can be used to perform the AGC functions as described herein. For example, the DL gain value can be stored in the VGA 820 for application to the UL subframes as described herein to effect power control during transmission. The UL power setting can be limited so as not to exceed UL MAX power output. The VGA 820 can further manage UL/DL transmit enable window by delaying or advancing the sliding window based on processor input and input from the analysis of the bins as described hereinabove. The VGA 820 can still further perform logic operations such as the transmit combinatorial control described hereinabove, to the rest of the repeater and other control such as the configuration of the transmit switches and the like, based on the UL/DL transmit enable window and detected power, such as the correlated power or RSSI power through operation of, for example, a state machine or the like.

The processor 850 can be configured to perform the UL/DL timing management, filtering functions, and any other calculations as described herein. The processor 850 can further manage the operation of the VGA 820 state machine through control signals coupled thereto. The processor 850 can further set configuration parameters and perform any other function requiring processor capabilities. It will be appreciated that much or all of the processor functionality can be realized through the execution of program instructions carried on a computer readable medium such as a memory device, ROM, disk or other medium including a connection medium such as a wired or wireless network connection. Alternatively, the instructions can be integrated into the processor in the form of an application specific integrated circuit (ASIC) or the like.

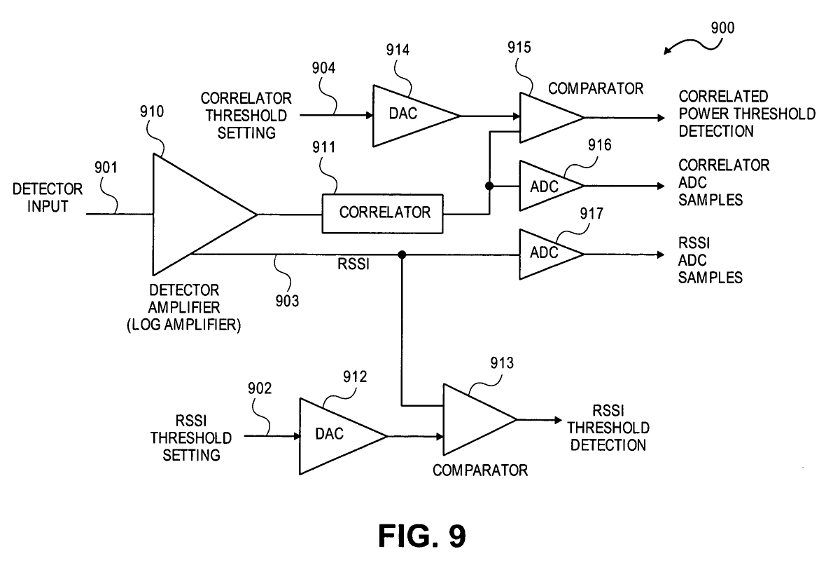

In order to carry out functions such as synchronization as described herein above, exemplary detectors are required such as those shown in FIG. 8. One such embodiment of the exemplary detectors is shown in FIG. 9. Detectors can be configured as shown, such as a detector amplifier 910 for generating an RSSI value 903 based on a detector input 901, which can be an input signal such as a radio frequency (RF) signal, for example as described above with reference to FIG. 8 as an IF signal from a receive antenna, or the like. The output of detector amplifier 910 can be passed to a correlator 911, which can be optionally included depending on the performance level required for the repeater. Threshold values such as a RSSI threshold value 902 and a correlator threshold setting 904 can be input to digital to analog converter DAC 912 and DAC 914 respectively for generating correlated power detection and RSSI threshold detection using an analog comparator 913 and 915. In addition, digital values can be generated for RSSI values using analog to digital converter (ADC) 917 and the correlator output values using ADC 916.

One of ordinary skill in the art will recognize that as noted above, various techniques can be used to determine different signal detector configurations and set detection thresholds and the like in the present invention. Additionally, various components, such as detector elements 309 and 311, combinatorial logic element 314, and the functionality of microcontroller 313 and other elements could be combined into a single integrated device. Other changes and alterations to specific components, and the interconnections thereof, can be made by one of ordinary skill in the art without deviating from the scope and spirit of the present invention.

What is claimed is:

1. A method for repeating a signal transmitted from a first station to a second station using a repeater configured according to a Time Division Duplex (TDD) protocol, the first station communicating to the second station on a downlink and the second station communicating to the first station on an uplink, the method comprising:
detecting the presence of the signal on one of the uplink and the downlink;
synchronizing the repeater to one or more time intervals associated with the detected signal, the one or more time intervals measured during an observation period to form one or more measured time intervals;
re-transmitting the signal from the second station to the first station if the signal is detected on the uplink; and
re-transmitting the signal from the first station to the second station, if the signal is detected on the downlink,
wherein a first gain value associated with the downlink is used to establish a second gain value associated with the uplink.

2. The method according to claim 1, wherein the detecting the presence of the signal includes detecting using a power detector.

3. The method according to claim 1, wherein the detecting the presence of the signal includes detecting using a correlator.

4. The method according to claim 1, wherein the detecting the presence of the signal includes detecting using a matched filter.

5. The method according to claim 1, wherein the synchronizing includes:
measuring of one of a received signal strength indicator (RSSI) vale and a correlation value associated with samples of the signal during the one or more measured time intervals to form one or more measured values; and
filling one or more signal processing bins with ones of the one or more measured values associated with the one or more measured time intervals such that the one or more measured time intervals are established by processing the one or more signal processing bins using a statistical procedure after the observation period expires.

6. The method according to claim 5, wherein the statistical procedure includes a power envelope sliding correlation function.

7. The method according to claim 5, wherein the detecting includes detecting one or more gaps between an uplink interval and a downlink interval using a windowing function.

8. The method according to claim 1, wherein the TDD protocol includes an IEEE 802.16 protocol.

9. The method according to claim 1, wherein the TDD protocol includes an IEEE 802.20 protocol.

10. The method according to claim 1, wherein the TDD protocol includes an IEEE 802.16(d) protocol.

11. The method according to claim 1, wherein the TDD protocol includes an IEEE 802.16(e) protocol.

12. The method according to claim 1, wherein the TDD protocol includes an IEEE 802.16(d/e) protocol.

13. The method according to claim 1, wherein the TDD protocol includes a Personal Handy-phone System (PHS) protocol.

14. The method according to claim 1, wherein the TDD protocol includes a time division synchronization code division multiple access (TDS-CDMA) protocol.

15. The method according to claim 1, wherein the first station includes a base station and the second station includes a subscriber terminal.

16. The method according to claim 1, wherein the first gain value includes a first automatic gain control (AGC) level for the downlink and the second gain value includes a power control value for the uplink.

17. The method according to claim 1, further comprising measuring an isolation between the uplink and the downlink and providing an indication of the isolation.

18. The method according to claim 1, wherein the repeater is divided into a first unit and a second unit and wherein the method further comprises communicating between the first unit and the second unit over a communication link.

19. A repeater repeating a signal transmitted from a first station to a second station, the repeater configured according to a Time Division Duplex (TDD) protocol, the first station communicating to the second station on a downlink and the second station communicating to the first station on an uplink, the repeater comprising:
an antenna;
a detector coupled to the antenna, the detector configured to detect the presence of the signal in an interval associated with one of the uplink and the downlink; and
a processor coupled to the antenna and the detector, the processor configured to:
measure one or more time intervals during an observation period associated with the detected signal, the one or more time intervals measured during an observation period to form one or more measured time intervals;
synchronize the repeater to the one or more time intervals such that a first one or more of the measured time intervals corresponds to one or more uplink intervals and a second one or more of the measured time intervals corresponds to one or more downlink intervals.

20. The repeater according to claim 19, further comprising a transmitter coupled to the antenna and the processor,
wherein the processor includes a gain controller, the processor further configured to:
re-transmit the signal using the transmitter from the first station to the second station on one of the one or more downlink intervals, the gain controller controlling a first gain value of the retransmitted signal if the signal is detected on the downlink; and
re-transmit the signal using the transmitter from the second station to the first station on one of the one or more uplink intervals, the gain controller controlling a second gain value if the signal is detected on the uplink,
wherein the first gain value is used to establish the second gain value.

21. The repeater according to claim 19, wherein the detector includes a power detector.

22. The repeater according to claim 19, wherein the detector includes a correlator.

23. The repeater according to claim 19, wherein the detector includes a matched filter.

24. The repeater according to claim 19, wherein the processor further includes a signal processor and wherein the processor in synchronizing the repeater, is further configured to:
measure one of a received signal strength indicator (RSSI) value and a correlation value associated with the signal at a sampling interval to form a measured value; and
filling one or more signal processing bins with values associated with the one or more measured time intervals such that the one or more timing intervals are established by processing the one or more signal processing bins using a statistical procedure after the observation period expires.

25. The repeater according to claim 24, wherein the statistical procedure includes a power envelope sliding correlation function.

26. The repeater according to claim 19, wherein the detector and the processor are configured to detect one or more gaps between an uplink interval and a downlink interval using a windowing function.

27. The repeater according to claim 19, wherein the TDD protocol includes one of an IEEE 802.16 protocol, an IEEE 802.20 protocol, an IEEE 802.16(d) protocol, an IEEE 802.16(e) protocol, an IEEE 802.16(d/e) protocol, a Personal Handy-phone System (PHS) protocol, and a time division synchronization code division multiple access (TDS-CDMA) protocol.

28. The repeater according to claim 20, wherein the first gain value includes a first automatic gain control (AGC) level for the downlink and the second gain value includes a power control value for the uplink.

29. The repeater according to claim 19, wherein the processor is further configured to:
measure an isolation between the uplink and the downlink; and
provide an indication of the isolation.

30. A repeater for repeating a signal transmitted from a first station to a second station and from the second station to the first station, the repeater configured according to a Time Division Duplex (TDD) protocol, the first station communicating to the second station on a downlink and the second station communicating to the first station on an uplink, the repeater comprising:
a first unit including:
a donor side antenna;
a first transmitter;
a first detector coupled to the donor side antenna, the detector configured to detect the presence of the signal in an interval associated with the downlink;
a first transmitter; and
a first processor coupled to the donor side antenna, the first detector, and the first transmitter, the first processor configured to:
measure a first one or more time intervals during an observation period associated with the detected signal, the first one or more time intervals measured during a first observation period to form first measured time intervals;
synchronize the repeater to the first one or more time intervals such that a first one or more of the first measured time intervals corresponds to one or more downlink intervals associated with the downlink; and
a second unit coupled to the first unit through a communications link, the second unit including:
a receptor side antenna;
a second detector coupled to the receptor side antenna, the second detector configured to detect the presence of the signal in an interval associated with the uplink;
a second transmitter; and
a second processor coupled to the receptor side antenna, the second detector, and the second transmitter, the second processor configured to:
measure a second one or more time intervals during an observation period associated with the detected signal, the second one or more time intervals measured during an observation period to form second measured time intervals;
synchronize the repeater to the second one or more time intervals such that a second one or more of the second measured time intervals corresponds to one or more uplink intervals associated with the uplink.

31. The repeater according to claim 30, wherein:
the first unit is further configured to:
transfer the signal from the first station to the second unit over the communication link in one of the one or more downlink intervals, a first gain value associated with re-transmission the signal set by the second unit if the signal is detected on the downlink; and
the second unit is further configured to:
re-transmit the signal to the second station in one of the one or more downlink intervals at the first gain value.

32. The repeater according to claim 30, wherein:
the second unit is further configured to:
transfer the signal from the second station to the first unit over the communication link, in one of the one or more uplink intervals, a second gain value associated with re-transmission of the signal set by the first unit if the signal is detected on the uplink; and
the first unit is further configured to:
re-transmit the signal to the first station in one of the one or more uplink intervals at the second gain value.

33. The repeater according to claim 30, wherein the TDD protocol includes one of an IEEE 802.16 protocol, an IEEE 802.20 protocol, an IEEE 802.16(d) protocol, an IEEE 802.16(e) protocol, an IEEE 802.16(d/e) protocol, a Personal Handy-phone System (PHS) protocol, and a time division synchronization code division multiple access (TDS-CDMA) protocol.

34. The repeater according to claim 31, wherein the first gain value includes a first automatic gain control (AGC) level for the downlink and the second gain value includes a power control value for the uplink.
